(19) United States
(12) Patent Application Publication
(10) Pub. No.: US 2016/0117050 A1
(43) Pub. Date: Apr. 28, 2016

(54) TOUCH FILTER CIRCUIT

(71) Applicant: Raydium Semiconductor Corporation, Hsinchu (TW)

(72) Inventors: Yu-Chin Hsu, Hsinchu City (TW); Meng-Yi Chen, Kaohsiung City (TW); Chih Yuan, New Taipei City (TW)

(21) Appl. No.: 14/919,599

(22) Filed: Oct. 21, 2015

(30) Foreign Application Priority Data
Oct. 23, 2014 (TW) 103136708

(51) Int. Cl. G06F 3/041

(52) U.S. Cl. CPC G06F 3/0418

(57) ABSTRACT

A touch filter circuit includes a conversion module and a space-domain filter module. The conversion module converts a plurality of analog touch data into a plurality of digital touch data. The space-domain filter module is coupled with the conversion module and receives the plurality of digital touch data, wherein the space-domain filter module generates a compensation average value according to the plurality of digital touch data and respectively generates a plurality of renewal space-domain touch data according to the plurality of digital touch data and the compensation average value.

### BACKGROUND OF THE INVENTION

1. Field of the Invention

This invention relates to a touch filter circuit, especially to a touch filter circuit capable of reducing noises and enhancing touch efficiency.

2. Description of the Related Art

In general, the touch efficiency of the conventional touch apparatus would be largely reduced due to the outer environmental interferences such as power, light source, RF, or display panel. For example, the touch display apparatus includes a touch module and a display module at the same time. In an in-cell structure, since touch electrodes of the touch module is adjacent to the display panel, the touch sensing would be easily interfered by the display signal on the display panel. In practical conditions, the display signal and other signals will affect the touch point sensing of the touch sensing chip.

In some prior arts, analog circuits are used in the touch apparatus to reduce the noises of the display module; however, the cost would be increased and the effect of reducing noises is limited. In other prior arts, the noises generated by the display signals are detected. Once larger amplitude of noise is detected, the frequency of touch signal will be changed to avoid that the noises and the touch signals have the same frequency. However, after the frequency of touch signal is changed, the firmware of the touch sensing chip will generate error touch determination. In addition, the method of changing the frequency of touch signal not only reduces touch efficiency but also increases hardware cost to restore baseline data in the memory.

### SUMMARY OF THE INVENTION

Therefore, the invention provides a touch filter circuit capable of reducing noises and enhancing touch efficiency to solve the above-mentioned problems.

A scope of the invention is to provide a touch filter circuit capable of generating a compensation average value to compensate the touch signals.

Another scope of the invention is to provide a touch filter circuit capable of using touch signals at two continuous timings to reduce the interference of time-varying noises.

A preferred embodiment of the invention is a touch filter circuit. In this embodiment, the touch filter circuit includes a conversion module and a space-domain filter module. The conversion module converts a plurality of analog touch data into a plurality of digital touch data. The space-domain filter module is coupled with the conversion module and receives the plurality of digital touch data, wherein the space-domain filter module generates a compensation average value according to the plurality of digital touch data and generates a plurality of renewal space-domain touch data according to the plurality of digital touch data and the compensation average value respectively.

In an embodiment, the touch filter circuit further includes a touch module. The touch module is coupled to the conversion module and includes a plurality of transmitting terminals and a plurality of receiving terminals, wherein the touch module outputs the plurality of analog touch data to the conversion module at the plurality of transmitting terminals and the plurality of receiving terminals.

In an embodiment, the touch module further includes a touch surface having a transmitting direction and a receiving direction which are interlaced, and the plurality of analog touch data is a plurality of touch sensing signals on the touch surface, the plurality of analog touch data is transmitted to the plurality of transmitting terminals or the plurality of receiving terminals along the transmitting direction or the receiving direction.

In an embodiment, the space-domain filter module uses one of the plurality of transmitting terminals or one of the plurality of receiving terminals as a renewal group respectively to generate the plurality of renewal space-domain touch data correspondingly.

In an embodiment, the space-domain filter module further has a critical range and the space-domain filter module selectively selects the plurality of digital touch data according to the critical range to generate the plurality of renewal space-domain touch data.

In an embodiment, the space-domain filter module determines the critical range according to a ground result.

In an embodiment, the space-domain filter module uses differences between the plurality of digital touch data and the compensation average value respectively to generate the plurality of renewal space-domain touch data, and the touch filter circuit confirms a touch result according to the plurality of renewal space-domain touch data.

Another preferred embodiment of the invention is a touch filter circuit. In this embodiment, the touch filter circuit includes a conversion module and a time-domain filter module. The conversion module converts a plurality of analog touch data into a plurality of digital touch data, wherein the plurality of digital touch data includes a first digital touch data and a second digital touch data at a first timing and a second timing respectively. The time-domain filter module is coupled with the conversion module and receives the plurality of digital touch data, wherein the time-domain filter module has a time-domain proportion and generates a first renewal time-domain touch data according to the first digital touch data, the second digital touch data, and the time-domain proportion.

Another preferred embodiment of the invention is a touch filter circuit. In this embodiment, the touch filter circuit includes a conversion module, a space-domain filter module and a time-domain filter module. The conversion module converts a plurality of analog touch data into a plurality of digital touch data, wherein the plurality of digital touch data includes a plurality of first digital touch data and a plurality of second digital touch data at a first timing and a second timing respectively. The space-domain filter module receives the plurality of first digital touch data and the plurality of second digital touch data, wherein the space-domain filter module generates a first compensation average value and a second compensation average value according to the plurality of first digital touch data and the plurality of second digital touch data respectively, and the space-domain filter module generates a plurality of first renewal space-domain touch data according to the plurality of first digital touch data and the first compensation average value and generates a plurality of second renewal space-domain touch data according to the plurality of second digital touch data and the second compensation average value respectively. The time-domain filter module is coupled with the space-domain filter module and receives the plurality of first renewal space-domain touch data and the plurality of second renewal space-domain touch data, wherein the time-domain filter module has a time-domain proportion and generates a first renewal time-domain touch data according to a first renewal space-domain touch data of the plurality of first renewal space-domain touch data, a second renewal space-domain touch data of the plurality of second renewal space-domain touch data, and the time-domain proportion.

Compared to the prior art, the touch filter circuit of the invention uses a compensation average value to adjust the original digital touch data. In practical conditions, the invention uses the compensated renewal space-domain touch data to replace the digital touch data to reduce the effect caused by noises. In addition, the touch error caused by the data drift phenomenon easily occurs in the past can be avoided due to the compensation average value. Moreover, the invention can use the time-domain proportion to process two touch data at different timings to effectively reduce the error caused by the time-varying signals. In another embodiment, the invention can also integrate the space-domain filter module with the time-domain filter module to achieve the effects of compensation and reducing time-varying signals at the same time.

The advantage and spirit of the invention may be understood by the following detailed descriptions together with the appended drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a schematic diagram of the touch filter circuit in an embodiment of the invention.

FIG. 2 illustrates a schematic diagram of the touch filter circuit in another embodiment of the invention.

FIG. 3 illustrates a schematic diagram of the touch filter circuit in another embodiment of the invention.

### DETAILED DESCRIPTION

A preferred embodiment of the invention is a touch filter circuit used in a touch display apparatus. In fact, the touch filter circuit of the invention can be a touch filter display circuit, but not limited to this.

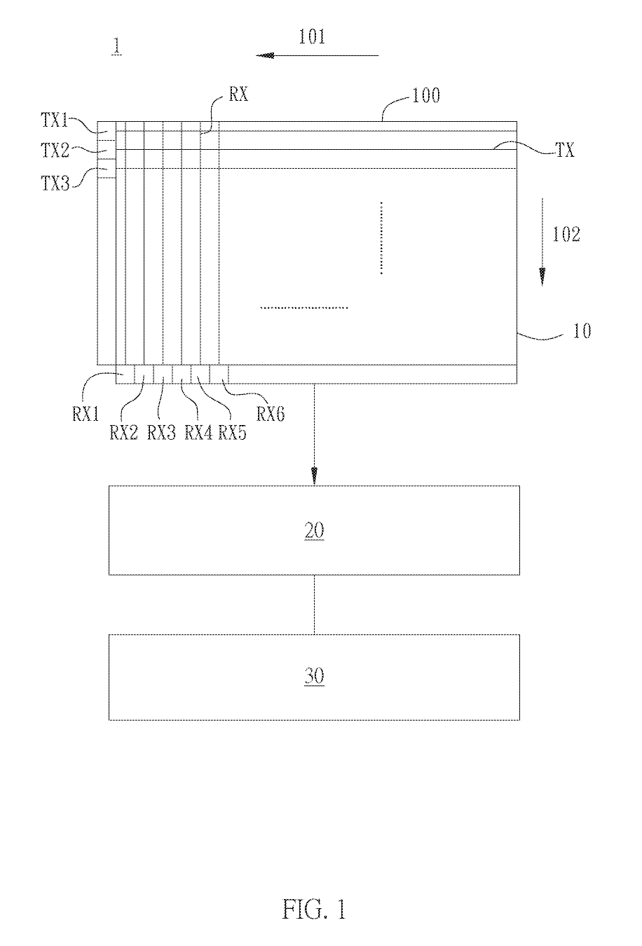

Please refer to FIG. 1. FIG. 1 illustrates a schematic diagram of the touch filter circuit in an embodiment of the invention. As shown in FIG. 1, the touch filter circuit 1 includes a touch module 10, a conversion module 20, and a space-domain filter module 30. In this embodiment, the touch module 10 is coupled to the conversion module 20 and includes a touch surface 100, a plurality of transmission lines TX, a plurality of receiving lines RX, a plurality of transmission terminals TX1, TX2, TX3, . . . , and a plurality of receiving terminals RX1, RX2, RX3, RX4, RX5, . . . , wherein the touch module 10 outputs a plurality of analog touch data to the conversion module 20 at the transmission terminals TX1˜TX3 and the receiving terminals RX1˜RX5.

The plurality of analog touch data is a plurality of touch sensing signals on the touch surface 100 and the touch surface 100 has a transmitting direction 101 and a receiving direction 102 which are interlaced. The plurality of analog touch data is transmitted to the plurality of transmitting terminals TX1˜TX3 or the plurality of receiving terminals RX1˜RX5 along a transmitting direction 101 or a receiving direction 102. It should be noticed that the transmitting direction 101 and the receiving direction 102 can be interlaced in any angles without specific limitations. In this embodiment, the transmitting direction 101 and the receiving direction 102 are orthogonally interlaced, and the angle between the transmitting direction 101 and the receiving direction 102 is 90°. In addition, the conversion module 20 converts the plurality of analog touch data into a plurality of digital touch data. In fact, the conversion module 20 is an analog/digital conversion module capable of converting the touch data from an analog type to a digital type, so that the touch data having the digital type can be processed in the following digital processing procedures.

In this embodiment, the space-domain filter module 30 is coupled to the conversion module 20 and receives the plurality of digital touch data. As shown in Table 1, Table 1 shows the plurality of digital touch data corresponding to the plurality of transmitting terminals TX1˜TX3 or the plurality of receiving terminals RX1˜RX6 respectively, wherein each number is digital touch data. The plurality of digital touch data can be obtained from the plurality of transmitting terminals TX1˜TX3 or the plurality of receiving terminals RX1˜RX6. For example, the space-domain filter module 30 can obtain analog touch data from the transmitting terminal TX1 and the analog touch data is converted into digital touch data 15, 14, 17, 15, 13, and 16 by the conversion module 20. In addition, the space-domain filter module 30 can also obtain analog touch data from the receiving terminal RX6 and the analog touch data is converted into digital touch data 16, 2, and 0 by the conversion module 20.

TABLE 1
digital touch data

| | RX1 | RX2 | RX3 | RX4 | RX5 | RX6 |
|---|---|---|---|---|---|---|
| TX1 | 15 | 14 | 17 | 15 | 13 | 16 |
| TX2 | −1 | 0 | −1 | −2 | 2 | 2 |
| TX3 | −8 | −4 | −4 | −2 | −2 | 0 |

In general, digital touch data will be floating around the value 0. In Table 1, the digital touch data captured by the transmitting terminals TX2 and TX3 will be around the value 0; however, the data drift phenomenon occurs at the transmitting terminal TX1, and the digital touch data captured by the transmitting terminal TX1 will be larger than 10.

In addition, the space-domain filter module 30 generates the compensation average value according to the digital touch data. In fact, the space-domain filter module 30 performs compensation for the space-domain to reduce the effects caused by the noises in the space-domain. It should be noticed that the space-domain filter module 30 uses the transmitting terminals or the receiving terminals as a renewal group respectively to generate corresponding renewal space-domain touch data. For example, the space-domain filter module 30 can use the data captured by the transmitting terminal TX1 as a renewal group and further use the renewal group to perform the touch compensation.

In this embodiment, the invention uses the transmitting terminals TX1, TX2, and TX3 as three renewal groups to perform the touch compensation, as shown in the following Equations 1-3:

TX1: (15+14+17+15+13+16)/6=15 (Equation 1)

TX2: (−1+0−1−2+2+0)/6=0 (Equation 2)

TX3: (−8−4−4−2−2+0)/6=−3 (Equation 3)

Wherein, the value 15 of Equation 1 is the compensation average value of the digital touch data of the transmitting terminal TX1; the value 0 of Equation 2 is the compensation average value of the digital touch data of the transmitting terminal TX2; the value −3 of Equation 3 is the compensation average value of the digital touch data of the transmitting terminal TX3. In other words, the compensation average value is an average value of the digital touch data captured by one transmitting terminal. In practical applications, even the data drift phenomenon occurs, the compensation average value can be still used to compensate the effects caused by noises. It should be noticed that the touch data captured along the transmission direction 101 is used as the renewal groups in this embodiment; in other embodiments, the touch data captured along the receiving direction 102 can be also used as the renewal groups.

In addition, the space-domain filter module 30 generates a plurality of renewal space-domain touch data according to the digital touch data and corresponding compensation average values. In fact, the space-domain filter module 30 uses the differences between the digital touch data and corresponding compensation average values to generate the plurality of renewal space-domain touch data respectively. And, the touch filter circuit 1 confirms the touch result according to the plurality of renewal space-domain touch data. In other words, the space-domain filter module 30 subtracts the compensation average values from the digital touch data to obtain the plurality of renewal space-domain touch data as shown in Table 2:

TABLE 2
renewal space-domain touch data

| | RX1 | RX2 | RX3 | RX4 | RX5 | RX6 |
|---|---|---|---|---|---|---|
| TX1 | 0 | −1 | 2 | 0 | −2 | 1 |
| TX2 | −1 | 0 | −1 | −2 | 2 | 0 |
| TX3 | −5 | −1 | −1 | 1 | 1 | 3 |

The values in Table 2 are renewal space-domain touch data, namely the compensated digital touch data. In detail, after the space-domain filter module 30 performs the compensation, the renewal space-domain touch data are used to replace the original digital touch data. As shown in Table 2, since the values of the renewal space-domain touch data are all around the value 0, it represents that this is an untouched state and the touch efficiency is largely increased.

In another embodiment, the space-domain filter module 30 has a critical range and the space-domain filter module 30 selectively selects the plurality of digital touch data according to the critical range to generate the plurality of renewal space-domain touch data. In fact, the space-domain filter module 30 determines the critical range according to a ground result. For example, a metal pillar (e.g., a copper pillar) can be disposed on the touch surface to detect the digital touch data values around the metal pillar to confirm the extreme values of the noises, so that the critical range can be determined accordingly. In this embodiment, the space-domain filter module 30 uses −25˜25 as the critical range. That is to say, only the digital touch data in the critical range are compensated, and the digital touch data out of the critical range are not compensated.

As shown in Table 3, the values in Table 3 are another set of digital touch data not compensated yet:

TABLE 3
digital touch data

| | RX1 | RX2 | RX3 | RX4 | RX5 | RX6 |
|---|---|---|---|---|---|---|
| TX1 | 15 | 14 | 17 | 26 | 13 | 16 |
| TX2 | −1 | 0 | 60 | 80 | 2 | 2 |
| TX3 | −8 | −4 | −4 | 27 | −2 | 0 |

In this embodiment, the digital touch data of the transmitting terminal TX1 has a value of 26 out of the critical range; the digital touch data of the transmitting terminal TX2 has a value of 60 and 80 out of the critical range; the digital touch data of the transmitting terminal TX3 has a value of 27 out of the critical range. In fact, the digital touch data having a value out of the critical range are usually the touched data on the touch surface 10. Therefore, only the digital touch data in the critical range are considered as the reference points to calculate the compensation average values as shown in the following Equations 4-6:

TX1: (15+14+17+13+16)/5=15 (Equation 4)

TX2: (−1+0+2+0)/4=0 (Equation 5)

TX3: (−8−4−4−2+0)/5=−3 (Equation 6)

Wherein, the compensation average values of the transmitting terminals TX1˜TX3 are 15, 0, and 3 respectively, and when the transmitting terminals TX1˜TX3 calculate the compensation average values, the digital touch data out of the critical range will not be considered at all.

In addition, after the compensation average values are calculated, the space-domain filter module 30 uses the compensation average values on the digital touch data to generate the renewal space-domain touch data as shown in the following Table 4:

TABLE 4
renewal space-domain touch data

| | RX1 | RX2 | RX3 | RX4 | RX5 | RX6 |
|---|---|---|---|---|---|---|
| TX1 | 0 | −1 | 2 | 11 | −2 | 1 |
| TX2 | −1 | 0 | 60 | 80 | 2 | 0 |
| TX3 | −5 | −1 | −1 | 30 | 1 | 3 |

Wherein, the renewal space-domain touch data 11 of the transmitting terminal TX1, the renewal space-domain touch data 60, 80 of the transmitting terminal TX2, and the renewal space-domain touch data 30 of the transmitting terminal TX3 are obviously higher touch values to be determined that these positions are touched and the touched data can be further detected. And, the other digital touch data will be around the value 0 after they are compensated, so that the touch efficiency can be enhanced.

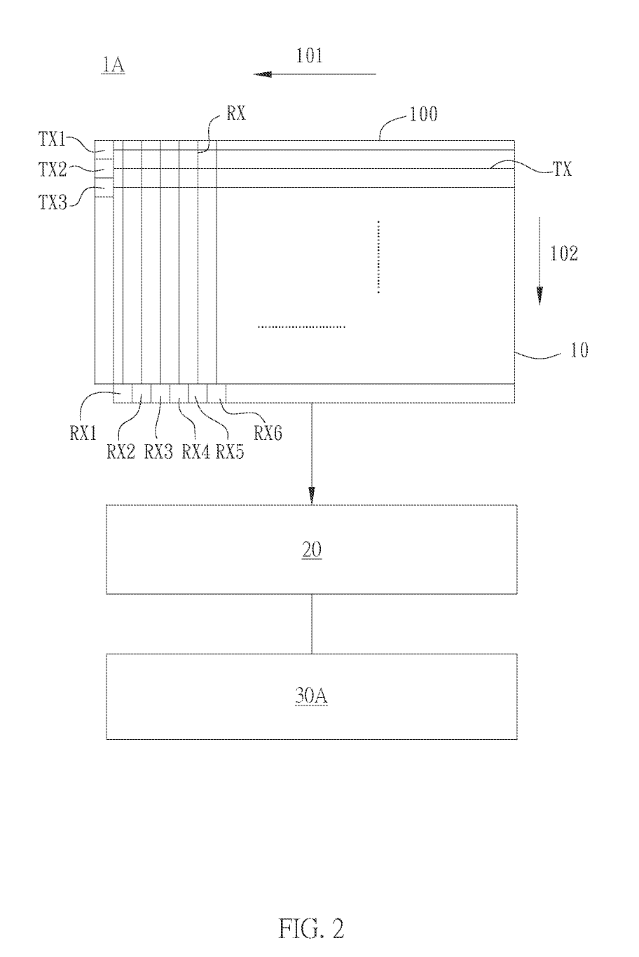

Please refer to FIG. 2. FIG. 2 illustrates a schematic diagram of the touch filter circuit in another embodiment of the invention. As shown in FIG. 2, compared with the embodiment of FIG. 1, the touch filter circuit 1A includes a time-domain filter module 30A. It should be noticed that the plurality of digital touch data includes a first digital touch data and a second digital touch data at a first timing and a second timing respectively, and the time-domain filter module 30A is coupled to the conversion module 20 and receives the digital touch data.

As shown in the following Table 5 and Table 6:

TABLE 5
digital touch data at the first timing

| | RX1 | RX2 | RX3 | RX4 | RX5 |
|---|---|---|---|---|---|
| TX1 | 15 | 14 | 3 | 15 | −1 |
| TX2 | −5 | −2 | −2 | 2 | 0 |
| TX3 | −18 | −16 | −9 | −3 | −6 |

TABLE 6
digital touch data at the second timing

| | RX1 | RX2 | RX3 | RX4 | RX5 |
|---|---|---|---|---|---|
| TX1 | −13 | −15 | −9 | 4 | −4 |
| TX2 | −3 | −2 | −3 | 4 | 3 |
| TX3 | −13 | −12 | −5 | 1 | −3 |

It should be noticed that the first timing and the second timing are two continuous timings, wherein the second timing is continuous to the first timing. In fact, the first timing can be a previous time frame and the second timing can be a current time frame, but not limited to this. In this embodiment, these digital touch data are distributed on the touch surface 100, wherein the value 15 of Table 5 is the first digital touch data and the value −13 of Table 6 is the second digital touch data, both of them correspond to the same position of the touch surface 100. In other words, the first digital touch data and the second digital touch data are the touch data value of the intersection point of the same transmission line and the same receiving line at the first timing and the second timing respectively.

In addition, the time-domain filter module 30A has a time-domain proportion and generates a first renewal time-domain touch data according to the first digital touch data, the second digital touch data, and the time-domain proportion. For example, the touch filter circuit 1A is applied to a 32-bit system, and the time-domain proportion can be 20:12, wherein the values 20 and 12 represent different touch proportions at the first timing and the second timing, but not limited to this. In other embodiments, the time-domain proportion can be also 24:8. If this time-domain proportion of 24:8 is used to calculate, the time-domain filter module 30A will emphasize the touch result at the first timing. On the contrary, if the time-domain proportion of 12:20 is used, the time-domain filter module 30A will emphasize the touch result at the second timing, and so on.

Taking the first digital touch data (value 15) and the second digital touch data (value −13) for example, as shown in the following Equation 7:

(15*20+(−13)*12)/32=4 (Equation 7)

Wherein, if the calculation result has the decimal point, the unconditional rounding method will be used. And, the value 32 of the denominator in Equation 7 is obtained according to (20+12). Therefore, the value of the first renewal time-domain touch data is 4, and other values of the first renewal time-domain touch data can be obtained so on, as shown in the following Table 7:

TABLE 7
first renewal time-domain touch data

| | RX1 | RX2 | RX3 | RX4 | RX5 |
|---|---|---|---|---|---|
| TX1 | 4 | 3 | −1 | 10 | −2 |
| TX2 | −4 | −2 | −2 | 2 | 1 |
| TX3 | −16 | −14 | −7 | −1 | −4 |

Compared to Table 6, the first renewal time-domain touch data shown in Table 7 can further reduce the effects caused by the noises. In fact, the digital touch data further includes third digital touch data at a third timing and the time-domain filter module 30A will generate a second renewal time-domain touch data according to the first renewal time-domain touch data, the third digital touch data, and the time-domain proportion. In other words, once the time-domain filter module 30A calculates the first renewal time-domain touch data according to the digital touch data at the first timing and the second timing, the first renewal time-domain touch data can be used to replace the digital touch data at the second timing. In addition, when the time-domain filter module 30A performs compensation on the third digital touch data at the third timing, the first renewal time-domain touch data and the third digital touch data at the third timing are directly used to generate the second renewal time-domain touch data to largely decrease the error percentage of touch sensing.

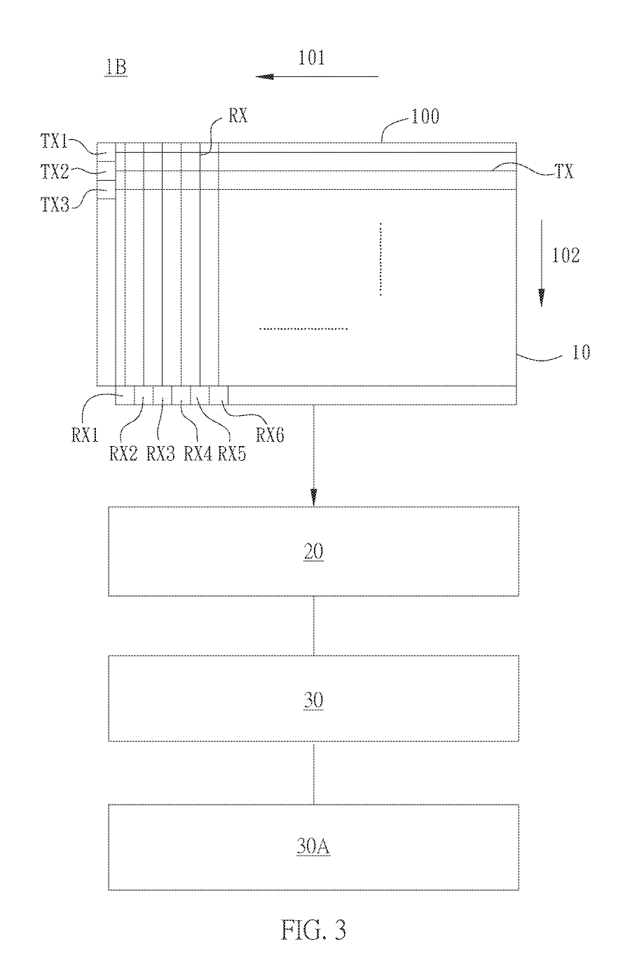

Please refer to FIG. 3. FIG. 3 illustrates a schematic diagram of the touch filter circuit in another embodiment of the invention. As shown in FIG. 3, the touch filter module 1B includes the space-domain filter module 30 and the time-domain filter module 30A at the same time. In other words, the touch filter module 1B can have two filtering functions at the same time: it can perform compensation in the space-domain and perform filtering in the time-domain.

In this embodiment, the plurality of digital touch data includes a plurality of first digital touch data and a plurality of second digital touch data at a first timing and a second timing respectively. The space-domain filter module 30 receives the plurality of first digital touch data and the plurality of second digital touch data, wherein the space-domain filter module 30 generates a first compensation average value and a second compensation average value according to the plurality of first digital touch data and the plurality of second digital touch data respectively.

Taking the digital touch data in Table 5 and Table 6 for example, wherein the digital touch data in Table 5 are the plurality of first digital touch data and the digital touch data in Table 6 are the plurality of second digital touch data in this embodiment.

In addition, the space-domain filter module 30 generates a plurality of first renewal space-domain touch data according to the plurality of first digital touch data and the first compensation average value; the space-domain filter module 30 also generates a plurality of second renewal space-domain touch data according to the plurality of second digital touch data and the second compensation average value respectively. In fact, the space-domain filter module 30 performs compensation on the plurality of first digital touch data of the first timing and the plurality of second digital touch data of the second timing respectively and further generates the plurality of first renewal space-domain touch data and the plurality of second renewal space-domain touch data. As shown in the following Table 8 and Table 9:

TABLE 8
first renewal space-domain
touch data of the first timing

| | RX1 | RX2 | RX3 | RX4 | RX5 |
|---|---|---|---|---|---|
| TX1 | 6 | 5 | −6 | 6 | −10 |
| TX2 | −4 | −1 | −1 | 3 | 1 |
| TX3 | 8 | −6 | 1 | 7 | 4 |

TABLE 9
second renewal space-domain
touch data of the second timing

| | RX1 | RX2 | RX3 | RX4 | RX5 |
|---|---|---|---|---|---|
| TX1 | −6 | −8 | −2 | 11 | 3 |
| TX2 | −3 | −2 | −3 | 4 | 3 |
| TX3 | 7 | −6 | 1 | 7 | 3 |

In Table 8, the compensation average values of the transmitting terminals TX1˜TX3 at the first timing are 9, (−1), and (−10) respectively. In Table 9, the compensation average values of the transmitting terminals TX1˜TX3 at the second timing are (−7), 0, and (−6) respectively. The above-mentioned compensation average values are used to compensate to obtain the renewal space-domain touch data in Table 8 and Table 9.

In practical applications, the space-domain filter module 30 uses the differences between the first digital touch data and corresponding first compensation average values to generate the plurality of first renewal space-domain touch data respectively. And, the touch filter circuit 1B confirms the touch result at the first timing and the second timing according to the plurality of renewal space-domain touch data. In addition, the space-domain filter module 30 uses the differences between the second digital touch data and corresponding second compensation average values to generate the plurality of second renewal space-domain touch data respectively.

Furthermore, the time-domain filter module 30A is coupled with the space-domain filter module 30 and receives the plurality of first renewal space-domain touch data and the plurality of second renewal space-domain touch data, wherein the time-domain filter module 30A has a time-domain proportion and generates a first renewal time-domain touch data according to a first renewal space-domain touch data of the plurality of first renewal space-domain touch data, a second renewal space-domain touch data of the plurality of second renewal space-domain touch data, and the time-domain proportion.

In this embodiment, the time-domain proportion can be 20:12. Taking the values 6 and (−6) at the interlaced positions of TX1 and RX1 in Table 8 and Table 9 for example, as shown in the following Equation 8:

(6*20+(−6)*12)/32=1 (Equation 8)

Wherein, the value of the first renewal time-domain touch data is 1 and the values of other first renewal time-domain touch data can be also obtained so on, as shown in the following Table 10:

TABLE 10
first renewal time-domain touch data

| | RX1 | RX2 | RX3 | RX4 | RX5 |
|---|---|---|---|---|---|
| TX1 | 1 | 0 | −4 | 7 | −5 |
| TX2 | −3 | −1 | −1 | 3 | 1 |
| TX3 | 7 | −6 | 1 | 7 | 3 |

Compared to Table 9, the first renewal time-domain touch data shown in Table 10 can further reduce the time-varying noises. In addition, the touch filter circuit 1B will use the first renewal time-domain touch data of Table 10 to replace the second renewal space-domain touch data of the second timing. In other words, the data in Table 10 is used to replace the data in Table 9.

In addition, the plurality of digital touch data further includes a third digital touch data at a third timing, the space-domain filter module 30 compensates the plurality of third digital touch data to generate a plurality of third renewal space-domain touch data, and the time-domain filter module 30A generates a second renewal time-domain touch data according to the first renewal time-domain touch data, a third renewal space-domain touch data of the plurality of third renewal space-domain touch data, and the time-domain proportion. As to the detail of the third timing, since it can be found in the above-mentioned embodiments, it is not repeated here.

Compared to the prior art, the touch filter circuit 1 of the invention uses a compensation average value to adjust the original digital touch data. In practical conditions, the invention uses the compensated renewal space-domain touch data to replace the digital touch data to reduce the effect caused by noises. In addition, the touch error caused by the data drift phenomenon easily occurs in the past can be avoided due to the compensation average value. Moreover, the touch filter circuit 1A of the invention can use the time-domain proportion to process two touch data at different timings to effectively reduce the error caused by the time-varying signals. In another embodiment, the touch filter circuit 1B of the invention can also integrate the space-domain filter module with the time-domain filter module to achieve the effects of compensation and reducing time-varying signals at the same time.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A touch filter circuit, comprising:
a conversion module, the conversion module converting a plurality of analog touch data into a plurality of digital touch data; and
a space-domain filter module, the space-domain filter module being coupled with the conversion module and receiving the plurality of digital touch data, wherein the space-domain filter module generates a compensation average value according to the plurality of digital touch data and generates a plurality of renewal space-domain touch data according to the plurality of digital touch data and the compensation average value respectively.

2. The touch filter circuit of claim 1, further comprising:
a touch module, coupled to the conversion module and comprising a plurality of transmitting terminals and a plurality of receiving terminals, wherein the touch module outputs the plurality of analog touch data to the conversion module at the plurality of transmitting terminals and the plurality of receiving terminals.

3. The touch filter circuit of claim 2, wherein the touch module further comprises:
a touch surface having a transmitting direction and a receiving direction which are interlaced, and the plurality of analog touch data is a plurality of touch sensing signals on the touch surface, the plurality of analog touch data is transmitted to the plurality of transmitting terminals or the plurality of receiving terminals along the transmitting direction or the receiving direction.

4. The touch filter circuit of claim 2, wherein the space-domain filter module uses one of the plurality of transmitting terminals or one of the plurality of receiving terminals as a renewal group respectively to generate the plurality of renewal space-domain touch data correspondingly.

5. The touch filter circuit of claim 1, wherein the space-domain filter module further has a critical range and the space-domain filter module selectively selects the plurality of digital touch data according to the critical range to generate the plurality of renewal space-domain touch data.

6. The touch filter circuit of claim 5, wherein the space-domain filter module determines the critical range according to a ground result.

7. The touch filter circuit of claim 1, wherein the space-domain filter module uses differences between the plurality of digital touch data and the compensation average value respectively to generate the plurality of renewal space-domain touch data, and the touch filter circuit confirms a touch result according to the plurality of renewal space-domain touch data.

8. A touch filter circuit, comprising:
a conversion module, the conversion module converting a plurality of analog touch data into a plurality of digital touch data, wherein the plurality of digital touch data comprises a first digital touch data and a second digital touch data at a first timing and a second timing respectively; and
a time-domain filter module, the time-domain filter module being coupled with the conversion module and receiving the plurality of digital touch data, wherein the time-domain filter module has a time-domain proportion and generates a first renewal time-domain touch data according to the first digital touch data, the second digital touch data, and the time-domain proportion.

9. The touch filter circuit of claim 8, further comprising:
a touch module, coupled to the conversion module and comprising a plurality of transmitting terminals and a plurality of receiving terminals, wherein the touch module outputs the plurality of analog touch data to the conversion module at the plurality of transmitting terminals and the plurality of receiving terminals.

10. The touch filter circuit of claim 8, wherein the plurality of digital touch data is distributed on a touch surface, and the first digital touch data and the second digital touch data correspond to the same position of the touch surface.

11. The touch filter circuit of claim 8, wherein the plurality of digital touch data further comprises a third digital touch data at a third timing, and the time-domain filter module generates a second renewal space-domain touch data according to the first renewal space-domain touch data, the third digital touch data, and the time-domain proportion.

12. A touch filter circuit, comprising:
a conversion module, the conversion module converting a plurality of analog touch data into a plurality of digital touch data, wherein the plurality of digital touch data comprises a plurality of first digital touch data and a plurality of second digital touch data at a first timing and a second timing respectively; and
a space-domain filter module, the space-domain filter module receiving the plurality of first digital touch data and the plurality of second digital touch data, wherein the space-domain filter module generates a first compensation average value and a second compensation average value according to the plurality of first digital touch data and the plurality of second digital touch data respectively, and the space-domain filter module generates a plurality of first renewal space-domain touch data according to the plurality of first digital touch data and the first compensation average value and generates a plurality of second renewal space-domain touch data according to the plurality of second digital touch data and the second compensation average value respectively; and
a time-domain filter module, the time-domain filter module being coupled with the space-domain filter module and receiving the plurality of first renewal space-domain touch data and the plurality of second renewal space-domain touch data, wherein the time-domain filter module has a time-domain proportion and generates a first renewal time-domain touch data according to a first renewal space-domain touch data of the plurality of first renewal space-domain touch data, a second renewal space-domain touch data of the plurality of second renewal space-domain touch data, and the time-domain proportion.

13. The touch filter circuit of claim 12, wherein the space-domain filter module uses differences between the plurality of first digital touch data and the first compensation average value respectively to generate the plurality of first renewal space-domain touch data and the space-domain filter module uses differences between the plurality of second digital touch data and the second compensation average value respectively to generate the plurality of second renewal space-domain touch data.

14. The touch filter circuit of claim 12, wherein the plurality of digital touch data further comprises a plurality of third digital touch data at a third timing, and the space-domain filter module compensates the plurality of third digital touch data to generate a plurality of third renewal space-domain touch data, and the time-domain filter module generates a second renewal time-domain touch data according to the first renewal time-domain touch data, a third renewal space-domain touch data of the plurality of third renewal space-domain touch data, and the time-domain proportion.
